(19) United States
(12) Patent Application Publication
(10) Pub. No.: US 2006/0051635 A1
(43) Pub. Date: Mar. 9, 2006

(54) Fuel cell system and control method thereof

(75) Inventor: Tetsuya Kamihara, Yokohama-shi (JP)

Correspondence Address: FOLEY AND LARDNER LLP;SUITE 500, 3000 K STREET NW, WASHINGTON, DC, 20007, US

(73) Assignee: NISSAN MOTOR CO., LTD.

(21) Appl. No.: 10/534,640

(22) PCT Filed: Jan. 30, 2004
(86) PCT No.: PCT/JP04/00965

§ 371 Date: May 12, 2005

(30) Foreign Application Priority Data
Feb. 20, 2003 (JP) 2003-043096
Nov. 19, 2003 (JP) 2003-389253

(51) Int. Cl. H01M 8/04

(52) U.S. Cl. 429/25; 429/24; 429/26; 429/13

(57) ABSTRACT

A control unit calculates an integration value resulting from integration of the amount of an impurity other than a fuel gas at a hydrogen electrode, which varies in accordance with a gas pressure at the hydrogen electrode and the temperature of a fuel cell stack, when a hydrogen purge valve is set in a closed state and controls the hydrogen purge valve in an open state when the integration value becomes equal to or greater than a threshold value. The control unit calculates an integration value resulting from integration of a discharge gas flow rate from the hydrogen purge valve, which varies in accordance with the gas pressure at the hydrogen electrode and the temperature of the fuel gas, when the hydrogen purge valve is set in the open state and controls the hydrogen purge valve in the closed state when the integration value becomes equal to or greater than a threshold value. This makes it possible to eliminate impurities culminated in a fuel gas system, to ensure stable power generation over a wide range of operational load, and to minimize the amount of fuel discharge, thereby improving the efficiency of fuel usage.

### TECHNICAL FIELD

The present invention relates to a fuel cell system and control method thereof suitable at the time of supplying a fuel gas and an oxidant gas to a fuel cell stack to generate power to drive a vehicle driving motor.

### BACKGROUND ART

A fuel cell system for generating a drive torque for a movable body of a vehicle is known through a technique disclosed in Japanese Patent Laid-Open Publication No. 2000-243417. Such a fuel cell system normally has a solid polymer type fuel cell stack which uses hydrogen as fuel and can ensure stable power generation by supplying more hydrogen than is consumed by the fuel cell stack.

The fuel cell system according to the patent publication supplies more hydrogen than is consumed without discarding excess hydrogen by circulating the excess hydrogen, discharged from the fuel cell stack, to the fuel inlet side of the fuel cell stack. Also, paying attention also to accumulation of an impurity gas other than hydrogen in the hydrogen system by a continuous operation, this fuel cell system eliminates impurities accumulated in the hydrogen system when the degree of power generation drops.

### DISCLOSURE OF INVENTION

However, a reduction in the degree of power generation of the above-described fuel cell system differs depending on the operational load of the fuel cell stack and there may be a case where even if the degree of power generation hardly falls in a low-load area, the degree of power generation has already dropped beyond the allowance range at a high load, thereby degrading the fuel cell stack. Therefore, there arises a problem that when the fuel cell system is adapted to a vehicle, and the operational load is changed to a high load from a very low load, the optimal timing to eliminate the impurity cannot be determined.

Accordingly, the preset invention has been proposed in order to solve the above-described problems, and aims to provide a highly efficient fuel cell system and control method thereof which eliminates impurities accumulated in a fuel gas system, ensures stable power generation over a wide range of operational loads and minimize the amount of fuel discharge.

A fuel cell system according to the present invention comprises a fuel cell stack having a fuel electrode and an oxidant electrode provided facing each other with an electrolyte membrane in between, a gas supply unit which supplies a fuel gas to the fuel electrode and supplies an oxidant gas to the oxidant electrode to cause the fuel cell stack to generate power, a circulation unit having a circulation passage to return an excess fuel gas, discharged from the fuel cell stack, to a fuel gas inlet port of the fuel cell stack, and a gas discharge unit having an open/close valve which discharges a gas present on the fuel electrode from the circulation passage, and controls opening/closing of the open/close valve by a control unit.

The fuel cell system according to the present invention overcomes the above-described problem by causing the control unit to calculate an integration value resulting from integration of a value per unit time concerning a gas to be supplied to the fuel electrode, which varies in accordance with a gas pressure of the oxidant electrode and a temperature of the fuel cell stack, when the open/close valve is set in a closed state, and control the open/close valve in an open state when the integration value becomes equal to or greater than an accumulation threshold value.

Another fuel cell system according to the present invention overcomes the above-described problem by causing the control unit to calculate an integration value resulting from integration of a discharge gas flow rate from the open/close valve, which varies in accordance with a gas pressure of the fuel electrode and a temperate of the fuel gas, when the open/close valve is set in an open state, and control the open/close valve in a closed state when the integration value becomes equal to or greater than a discharge threshold value.

A still another fuel cell system according to the present invention overcomes the above-described problem by setting an initial value of the integration value to be calculated in case of controlling the open/close valve in the open state lower and calculating an integration value resulting from integration of the value per unit time concerning the gas to be supplied to the fuel electrode, as the temperature of the fuel cell stack when the open/close valve is operated to the closed state from the open state of the open/close valve becomes higher.

Other and further features, advantages, and benefits of the present invention will become more apparent from the following description taken in conjunction with the following drawings.

### BRIEF DESCRIPTION OF THE DRAWINGS

FIG. 1 is a block diagram showing a configuration of a fuel cell system according to the first embodiment of the present invention.

FIG. 2 is a diagram showing a relationship of an amount of nitrogen in the hydrogen system, a circulating hydrogen flow rate, and a hydrogen gas temperature.

FIG. 3 is a flowchart showing a procedure of a purge valve control process of the fuel cell system according to the first embodiment of the present invention.

FIG. 4 is a diagram showing a relationship of a flow rate of transmitted nitrogen with respect to an air pressure and a tempera of a fuel cell stack.

FIG. 5 is a diagram showing a relationship between the hydrogen gas temperature and an accumulation threshold value.

FIG. 6 is a diagram showing a relationship of a gas flow rate discharged from a hydrogen purge valve with respect to a hydrogen pressure and the hydrogen gas temperature.

FIG. 7 is a flowchart showing a procedure of the purge valve control process of the fuel cell system according to the second embodiment of the present invention.

FIG. 8 is a diagram showing a relationship between the temperature of the fuel cell stack and an integration initial value.

FIG. 9 is a diagram showing a relationship between a coolant temperature and a discharge threshold value.

FIG. 10 is a diagram showing changes of amount of nitrogen when the hydrogen gas temperature is low and the hydrogen gas temperature is high, when a purge valve control process is performed by the fuel cell system according to the second embodiment of the present invention.

### BEST MODE FOR CARRYING OUT THE INVENTION

There will be explained hereinafter fuel cell system of the embodiments according to the present invention in detail with reference to the drawings.

### First Embodiment

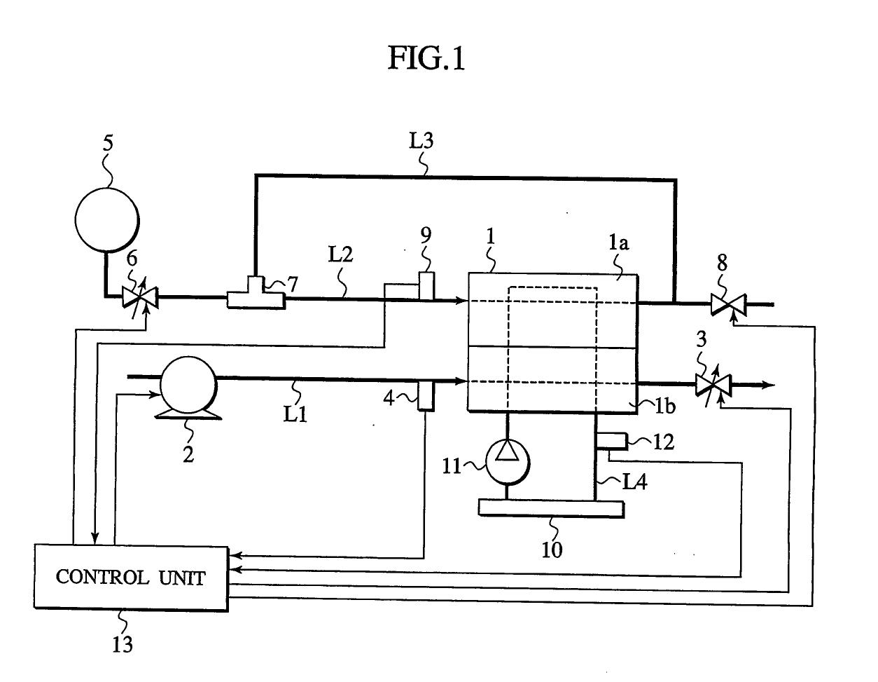

The present invention is adapted to a fuel cell system according to the first embodiment of the invention configured as shown in FIG. 1.

Configuration of Fuel Cell System

As shown in FIG. 1, this fuel cell system has a fuel cell stack 1 which generates power as a fuel gas and an oxidant gas are supplied. This fuel cell stack 1 is configured as a fuel cell configuration having an air electrode and a hydrogen electrode provided facing each other with a solid polymer electrolyte membrane in between is held with a separator and a plurality of cell configurations are laminated. In this embodiment, a fuel cell system is described which supplies a hydrogen gas to a hydrogen electrode 1a as a fuel gas for the fuel cell stack 1 to generate a power generation reaction and supplies oxygen to an air electrode 1b as an oxidant gas.

At the time of causing the fuel cell stack 1 to generate power, this fuel cell system supplies a humidified hydrogen gas to the hydrogen electrode 1a and supplies humidified air to the air electrode 1b. The air is compressed by a compressor 2 and is supplied to the air electrode 1b of the fuel cell stack 1 through an air supply passage L1. At this time, the fuel cell system controls the number of rotations of a compressor motor connected to the compressor 2 and controls the degree of opening of an air regulator 3 provided on the air discharge side of the air electrode 1b to adjust the flow rate of air and the air pressure which are to be supplied to the air electrode 1b.

The fuel cell system reads a sensor signal from a pneumatic sensor 4 which detects the air pressure to be supplied to the air electrode 1b and controls the air pressure regulator 3 in such a way that it becomes a target air pressure.

Hydrogen is supplied to the hydrogen electrode 1a through a hydrogen supply passage L2 passing a hydrogen pressure regulator 6 and an ejector pump 7 from the state where it is retained in a high-pressure hydrogen cylinder 5. Unused hydrogen discharged from the hydrogen electrode 1a is returned to the ejector pump 7 via a hydrogen circulation passage L3 and is circulated back to the hydrogen electrode 1a via the hydrogen supply passage L2 by the ejector pump 7.

At this time, the fuel cell system controls the degree of opening of the hydrogen pressure regulator 6 to adjust the hydrogen pressure to be supplied to the hydrogen electrode 1a. The fuel cell system also reads a sensor signal from a hydrogen pressure sensor 9 which detects the hydrogen pressure to be supplied to the hydrogen electrode 1a and controls the hydrogen pressure regulator 6 in such a way that it becomes a target hydrogen pressure.

In the fuel cell system, a hydrogen purge valve 8 is provided on the hydrogen discharge side of the hydrogen electrode 1a. The open/close action of this hydrogen purge valve 8 is controlled by the fuel cell system and the open/close action is taken according to the status of the fuel cell stack 1. At the time of preventing the occurrence of water clogging in the fuel cell stack 1 and power drop or a reduction in power generation efficiency caused by air leakage to the hydrogen electrode 1a from the air electrode 1b, the fuel cell system temporarily discharges the hydrogen gas in the hydrogen electrode 1a or the hydrogen circulation passage L3 from the fuel cell stack 1 by setting the purge valve 8 in an open state.

Furthermore, the fuel cell system has a coolant supply system for adjusting the temperature of the fuel cell stack 1 at the time of causing the fuel cell stack 1 to generate power. This coolant supply system is configured by providing a radiator 10 and a coolant pump 11 in a coolant passage L4. Such a coolant supply system is configured in such a way as to feed the coolant, pumped out from the coolant pump 11, to the coolant passage L4 in the fuel cell stack 1 and lead the coolant, discharged from the fuel cell stack 1, to the radiator 10 and return it back to the coolant pump 11. In this coolant supply system, a coolant temperature sensor 12, which detects a coolant temperature at that portion of the coolant passage L4 where the coolant discharged from the fuel cell stack 1 is supplied, is provided at the portion.

Furthermore, the fuel cell system has a control unit 13 which controls the individual section configured as described above. The control unit 13 stores inside a control program for controlling the individual section, and causes the fuel cell stack 1 to generate power and executes a purge valve control process to be discussed later by executing the control program.

At this time, in response to reception of an external request for power generation of the fuel cell stack 1, the control unit 13 reads the sensor signals from the pneumatic sensor 4 and the hydrogen pressure sensor 9 and detects the air pressure and hydrogen pressure supplied to the fuel cell stack 1. Accordingly, to cause the fuel cell stack 1 to generate power which satisfies the power generation request, the control unit 13 adjusts the air flow rate and air pressure by regulating the drive amount of the compressor 2 and the degree of opening of the air regulator 3 and adjusts the hydrogen flow rate and hydrogen pressure by regulating the degree of opening of the hydrogen pressure regulator 6. At this time, because heat is generated as the fuel cell stack 1 generates power, the control unit 13 detects the temperature of the fuel cell stack 1 by reading the sensor signal from the coolant temperature sensor 12 and controls the drive amount of the coolant pump 11 and the degree of cooling by the radiator 10.

When the normal operation is carried out in this way, the fuel cell system ensures stable power generation of the fuel cell stack 1 and improves the reaction efficiency in the hydrogen system by returning the hydrogen gas, discharged from the fuel cell stack 1, to the ejector pump 7 via the hydrogen circulation passage L3 and causing the ejector pump 7 to circulate hydrogen in such a way that it is led back to the fuel cell stack 1.

The control unit 13 normally controls the hydrogen purge valve 8 in the closed state and performs a purge valve control process to set the hydrogen purge valve 8 in the open state to discharge impurities, essentially containing nitrogen and other than hydrogen, outside when nitrogen is diffused from the air electrode 1b and accumulated in the hydrogen system. Here, the control unit 13 may execute the purge valve control process upon detection of the accumulation of a nitrogen-contained impurity other than hydrogen as well as the case where nitrogen is accumulated.

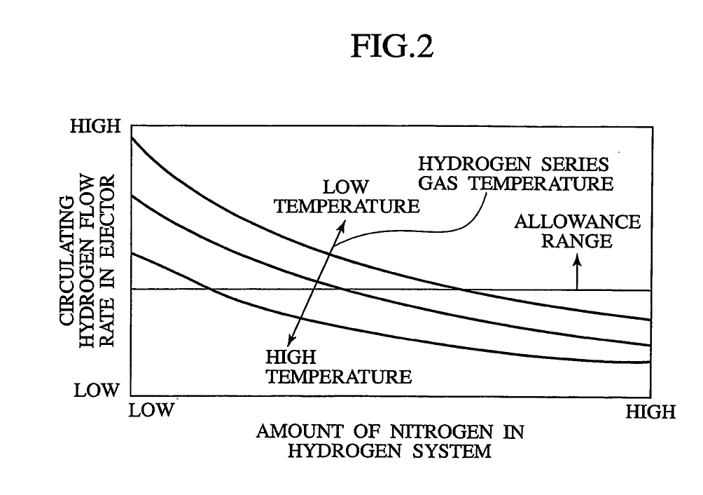

That is, for the fuel cell stack 1 to stably generate power in such a fuel cell system, it is necessary to secure approximately a constant amount of hydrogen circulated or greater according to the load demanded on the fuel cell stack 1. Here, because, as shown in FIG. 2, the relationship between the amount of nitrogen in the hydrogen system and the circulating hydrogen flow rate of the ejector pump 7 is such that as the amount of nitrogen in the hydrogen system increases, the hydrogen density decreases and the average amount of gas molecules in the hydrogen system increases, the ejector circulating hydrogen flow rate becomes lower. When the gas temperature in the hydrogen system is high, the vapor partial pressure in the hydrogen system rises to reduce the circulating hydrogen flow rate, so that the maximum amount of nitrogen allowable in the hydrogen system becomes smaller in case of a high temperature. In the fuel cell system, therefore, the following purge valve control process is executed in such a way as not to increase the amount of nitrogen in the hydrogen system with respect to the flow rate of hydrogen.

Purge Valve Control Process in Fuel Cell System

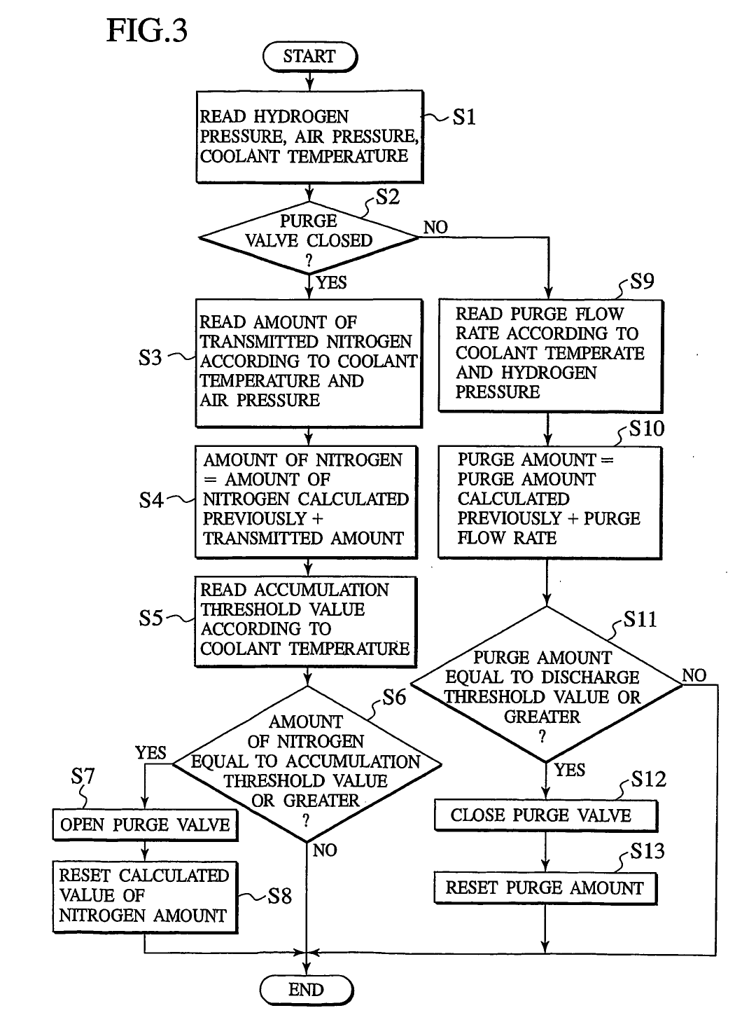

Next, the purge valve control process to control the open/close action of the hydrogen purge valve 8 by the control unit 13 in the fuel cell system configured in the above-described manner is described referring to a flowchart in FIG. 3.

With the fuel cell system activated, the control unit 13 starts a process at and following step S1 every predetermined period. First, in step S1, the control unit 13 detects the air pressure and hydrogen pressure and the temperature of the fuel cell stack 1 and a coolant temperature equivalent to a gas temperature at the hydrogen electrode 1a by reading sensor signals from the pneumatic sensor 4, the hydrogen pressure sensor 9 and the coolant temperature sensor 12, and proceeds the process to step S2. The reason for detecting the coolant temperature is because the coolant temperature has a strong correlation with the hydrogen gas temperature in the hydrogen electrode 1a and the air temperature in the air electrode 1b.

In step S2, the control unit 13 detects the current open/closed state of the hydrogen purge valve 8 and determines whether the hydrogen purge valve 8 is in the closed state. The control unit 13 proceeds the process to step S3 when the hydrogen purge valve 8 is in the closed state, and proceeds the process to step S9 when the hydrogen purge valve 8 is in the open state.

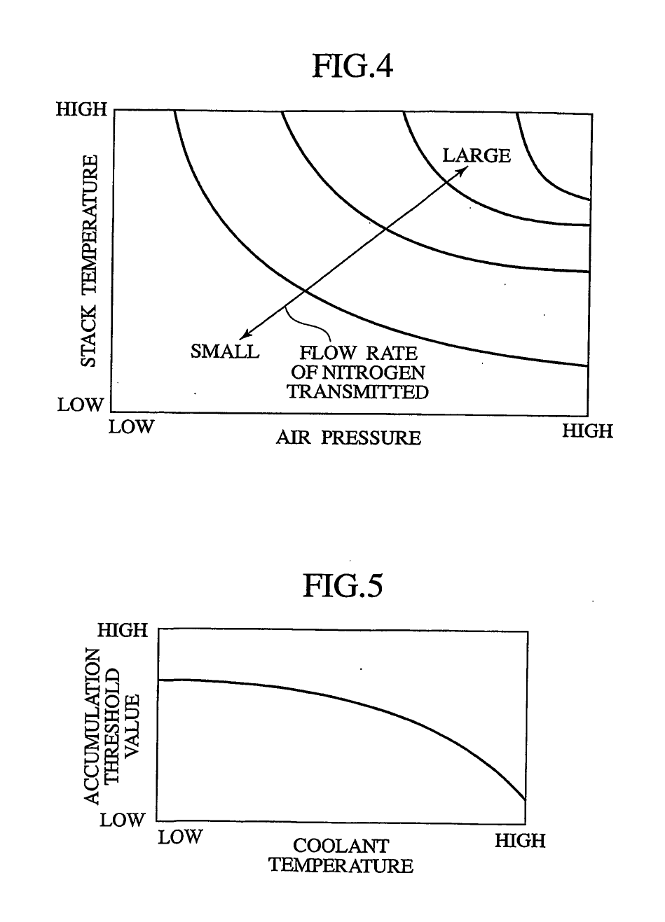

In step S3, the control unit 13 retrieves the flow rate of transmitted nitrogen as a value per unit time concerning a gas to be supplied to the fuel electrode from the air pressure and the coolant temperature detected in step S1. At this time, the control unit 13 predicts the flow rate of transmitted nitrogen, which is diffused to the hydrogen electrode 1a from the air electrode 1b, from the air pressure and the coolant temperature detected in step S1 by referring to prestored map data, as shown in FIG. 4, which describes the flow rate of transmitted nitrogen with respect to the air pressure and coolant temperature (temperature of the fuel cell stack 1). The map data shown in FIG. 4 is what already acquired by experiments, and is described in such a way that the higher the air pressure and the temperature of the fuel cell stack 1 are, the larger the flow rate of transmitted nitrogen becomes.

In the next step S4, the control unit 13 adds the flow rate of transmitted nitrogen calculated in step S4 of the previous purge valve control process and the flow rate of transmitted nitrogen predicted in the current step S3 to calculate the current flow rate of transmitted nitrogen in the hydrogen electrode 1a (integration value of the amount of nitrogen). As the flow rate of transmitted nitrogen which is the accumulation of the amounts of transmitted nitrogen up to the previous time is added to the current flow rate of transmitted nitrogen, the control unit 13 acquires an integrated value of the flow rate of transmitted nitrogen.

In the next step S5, the control unit 13 calculates, from the coolant temperature detected in Step S1, an accumulation threshold value which is the value of the amount of nitrogen that is allowed to be accumulated in the hydrogen electrode 1a. At this time, the control unit 13 predicts an accumulation threshold value, which is diffused to the hydrogen electrode 1a, from the coolant temperature detected in step S1 by referring to prestored map data, as shown in FIG. 5, which describes the accumulation threshold value with respect to the coolant temperature (hydrogen gas temperature). The map data shown in FIG. 5 is what already acquired by experiments, and is described in such a way that the higher the coolant temperature is, the smaller the accumulation threshold value becomes.

In the next step S6, the control unit 13 determines whether the flow rate of transmitted nitrogen acquired through integration in step S4 is equal to or greater than the accumulation threshold value acquired in step S5. When the control unit 13 determines that the flow rate of transmitted nitrogen acquired through integration is not equal to or greater than the accumulation threshold value, it terminates the process, whereas it determines that the flow rate of transmitted nitrogen acquired through integration is equal to or greater than the accumulation threshold value, it proceeds the process to step S7. Here, at the time of terminating the process, the control unit 13 holds the flow rate of transmitted nitrogen obtained through integration in step S4 in order to use it in step S4 in the next purge valve control process.

In step S7, the control unit 13 determines from the result of decision in step S6 that there is a possibility that as the amount of nitrogen transmitted to the hydrogen electrode 1a from the air electrode 1b increases, the circulating hydrogen flow rate drops and the fuel cell stack 1 cannot be operated stably, and controls the hydrogen purge valve 8 in the open state. Accordingly, the fuel cell system discharges a gas containing a lot of nitrogen in the hydrogen electrode 1a and the hydrogen circulation passage L3 outside.

In the next step S8, the control unit 13 resets the flow rate of transmitted nitrogen integrated and held in step S4 and terminates the process.

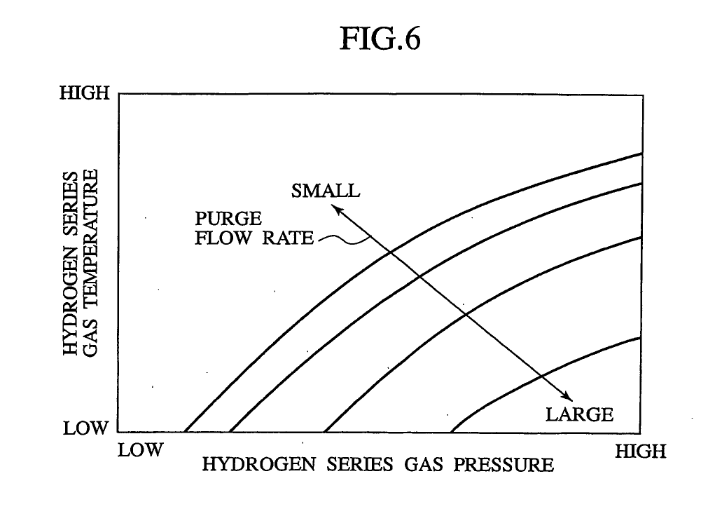

Meanwhile, in step S9 after deciding that, through execution of the processes of the above-described steps S1 to S8, for example, the hydrogen purge valve 8 in step S2 of the next purge valve control process is an open state, the control unit 13 calculates a purge flow rate which is the amount of gas discharged out from the hydrogen electrode 1a from the coolant temperature and hydrogen pressure detected in step S1. At this time, the control unit 13 predicts the purge flow rate from the hydrogen gas temperature equivalent to the coolant temperature detected in step S1 and the detected hydrogen pressure by referring to map data which describes a purge flow rate per unit time with respect to the prestored hydrogen gas pressure and hydrogen gas temperature as shown in FIG. 6. The map data shown in FIG. 6 is what already acquired by experiments, and is described in such a way that the higher the hydrogen gas temperature is, the smaller the purge flow rate is made by increasing the vapor partial pressure, and the higher the hydrogen pressure is, the larger the purge flow rate becomes.

In the next step S10, the control unit 13 adds the purge flow rate calculated in step S10 in the previous purge valve control process and the purge flow rate calculated in current step S9 to calculate the current purge flow rate (integration value). As the purge flow rate which is the accumulation of the purge flow rates up to the previous time is added to the current purge flow rate, the control unit 13 acquires an integrated value of the purge flow rate.

In the next step S11, the control unit 13 determines whether the hydrogen purge valve 8 is in the closed state by determining whether the purge flow rate acquired through integration in step S10 (integration value of the discharge gas flow rate) is equal to or grater than a preset discharge threshold value. Here, the discharge threshold value is what already acquired by experiments, and the purge flow rate that can provide at least the amount of nitrogen which is allowed to be accumulated at the hydrogen electrode 1a is set.

When the control unit 13 decides that the purge flow rate acquired through integration is not equal to or greater than the discharge threshold value, it terminates the press leaving the hydrogen purge valve 8 in the open state. Here, the control unit 13 holds the purge flow rate obtained through integration in step S10 in order to use it in step S10 in the next purge valve control process. Meanwhile, in step S12 after determining that the purge flow rate obtained through integration is equal to or greater than the discharge threshold value, the control unit 13 determines that a sufficient amount of nitrogen is discharged and controls the hydrogen purge valve 8 in the closed state, thereby finishing the operation of discharging a nitrogen-contained gas from the hydrogen electrode 1a.

In the next step S13, the control unit 13 resets the purge flow rate integrated and held in step S10 and terminates the process.

As described above in detail the fuel cell system according to the first embodiment of the present invention, the control unit 13 predicts the amount of nitrogen accumulated in the hydrogen electrode 1a according to the operational state of the fuel cell stack 1 by acquiring the flow rate of diffused nitrogen as a value per unit time concerning the gas to be supplied to the fuel electrode using the map data as shown in FIG. 3 and integrating it and discharges nitrogen by opening the hydrogen purge valve 8 when the amount becomes the amount of nitrogen of the accumulation threshold value set according to the hydrogen gas temperature. Accordingly, this configuration can minimize the frequency to set the hydrogen purge valve 8 in the open state and secure the circulating hydrogen amount to make it possible to keep power generation of the fuel cell stack 1 stably over a wide range of operational loads. It is also possible to efficiently remove impurities accumulated in the fuel cell stack 1, thereby suppressing degradation of the fuel cell stack 1 to minimum.

According to the fuel cell system, while the hydrogen purge valve 8 is closed, the control unit 13 integrates a predetermined value according to the air pressure and the temperature of the fuel cell stack 1 (the amount of nitrogen which flows into the hydrogen electrode 1a) and sets the hydrogen purge valve 8 in the open state when the integration value becomes equal to or greater than a predetermined accumulation threshold value. Accordingly, with this configuration, shortage of the circulating hydrogen amount caused by the accumulation of nitrogen in the hydrogen electrode 1a can be prevented by adequately determining the timing of setting the hydrogen purge valve 8 in the open state without using the hydrogen density sensor. It is also possible to suppress wasteful discharge of hydrogen together with nitrogen in over purging and ensure the stable operation of the fuel cell stack 1 over a wide range of operational loads. The efficiency of hydrogen usage can be increased.

Furthermore, according to this fuel cell system, the control unit 13 sets the flow rate of transmitted nitrogen greater as the temperature of the fuel cell stack 1 is higher and sets it greater as the air pressure becomes higher. Accordingly, this configuration can acquire a value close to the actual amount of nitrogen accumulated, and can execute accurate control.

Furthermore, according to this fuel cell system, the control unit 13 makes the threshold value of the amount of nitrogen to be used at the time of seeing the hydrogen purge valve 8 in the open state smaller as the hydrogen gas temperature corresponding to the coolant temperature becomes higher. Accordingly, this configuration can minimize the frequency of setting the hydrogen purge valve 8 in the open state.

Furthermore, according to this fuel cell system, the control unit 13 predicts the hydrogen gas temperature and the temperature of the fuel cell stack 1 from the coolant temperature. Accordingly, this configuration can control the opening/closing of the hydrogen purge valve 8 without using various temperature sensors.

Furthermore, according to this fuel cell system, the control unit 13 integrates the purge flow rate corresponding to the hydrogen pressure and hydrogen gas temperature while the hydrogen purge valve 8 is open, and closes the hydrogen purge valve 8 when the integration value becomes equal to or greater than a predetermined discharge threshold value. Accordingly, this configuration can adequately determine the timing for setting the hydrogen purge valve 8 in the closed state without using a hydrogen sensor, thereby ensuring suppression of the discharge amount of hydrogen and the stable operation of the fuel cell stack 1.

Furthermore, according to this fuel cell system, the control unit 13 sets the purge flow rate smaller as the hydrogen gas temperature becomes higher. Accordingly, this configuration can acquire a value close to the actual purge flow rate so that more accurate control can be carried out

### Second Embodiment

A fuel cell system according to the second embodiment is described next. With regard to those portions which are similar to the portions of the above-described first embodiment, same reference symbols are given and their detailed description is omitted. Because the configuration of the fuel cell system according to the second embodiment is the same as that of the first embodiment, its description is omitted too.

The fuel cell system according to the second embodiment is d in that the discharge threshold value is changed according to the temperature of the fuel cell stack 1. The fuel cell system according to the second embodiment is also characterized in that in place of the previous flow rate of transmitted nitrogen (integration value) used in the step, the integration initial value is used in the first purge valve control process after the hydrogen purge valve 8 is changed to the closed state from the open state.

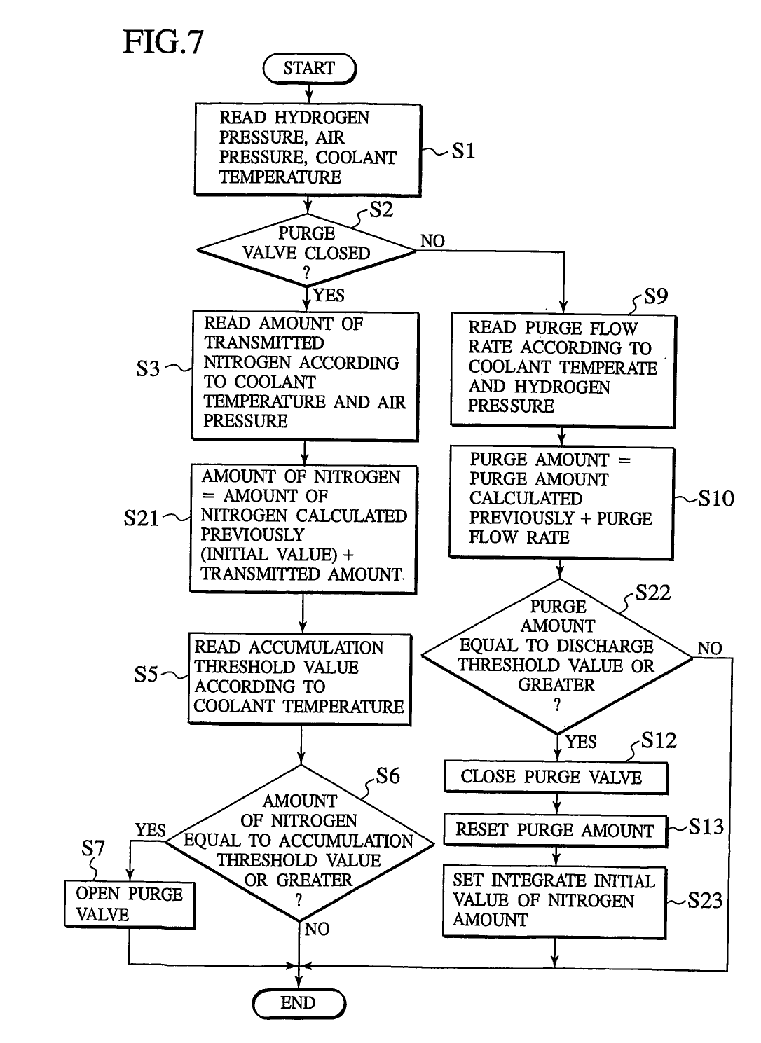

According to the fuel cell system, as shown in FIG. 7, the control unit 13 performs the processes of the steps S1 to S3 in the same way as described above and proceeds the process to step S21 in the first purge valve control process after the hydrogen purge valve 8 has been set to the closed state from the open state in the previous purge valve control process.

In the next step S21, the control unit 13 adds the integration initial value and the flow rate of transmitted nitrogen per unit time predicted in the current step S3 to calculate the current flow rate of transmitted nitrogen in the hydrogen electrode 1a. Here, the integration initial value is set by the control unit 13 in step S23 after the purge flow rate has been reset in step S13 in the previous purge valve control process so as to be used in step S21.

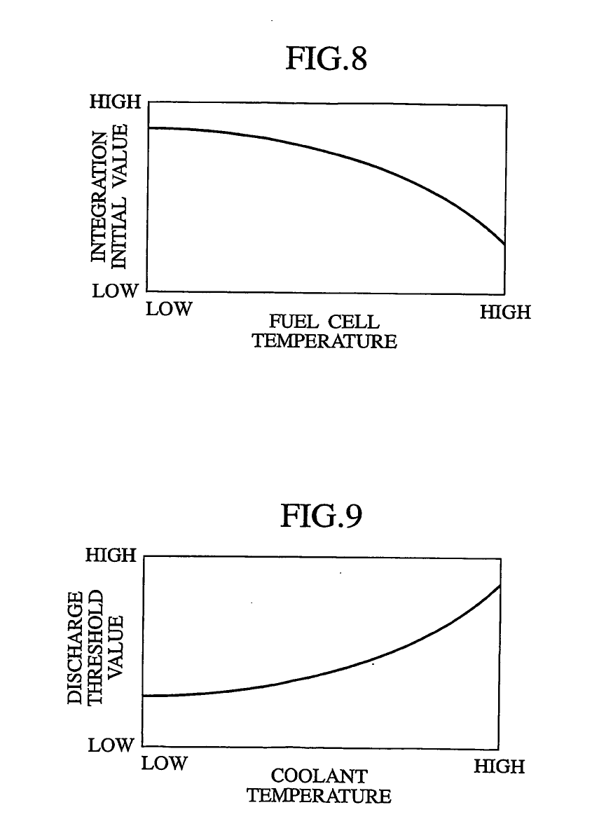

In this step S23, the control unit 13 acquires the integration initial value by referring to prestored map data as shown in FIG. 8 describing the integration initial value corresponding to the temperature of the fuel cell stack 1. At this time, the control unit 13 transforms the coolant temperature to the temperature of the fuel cell stack 1 and sets the integration initial value smaller as the transformed temperature of the fuel cell stack 1 becomes higher. This map data shown in FIG. 8 is what already acquired by experiments, and describes the integration initial value that becomes smaller as the temperature of the fuel cell stack 1 becomes higher.

Accordingly, the control unit 13 acquires the accumulation threshold value in the same way as described above (step S5), and compares it with the amount of nitrogen integration value) acquired by adding the accumulation threshold value and the integration initial value (step S6) and determines whether it is necessary to set the hydrogen purge valve 8 in the open state.

In the fuel cell system, when it is determined that the integration value of the flow rate of transmitted nitrogen has exceeded the accumulation threshold value while the processes of steps S1 to S6 are repeated, the control unit 13 sets the hydrogen purge valve 8 in the open state in step S7 and starts the next purge valve control process. In this purge valve control process, the fuel cell system executes the processes of step S1 and step S2 and the processes of step S9 and step S10 and proceeds the process to step S22 as per the above-described processes.

In step S22, the control unit 13 acquires the discharge threshold value corresponding to the coolant temperature according to the hydrogen gas temperature detected in step S1, and compares the discharge threshold value with the purge flow rate obtained in step S10. At this time, the control unit 13 acquires the discharge threshold value by referring to map data as shown in FIG. 9 describing a discharge threshold value corresponding to the coolant temperature. The map data shown in FIG. 9 is what already acquired by experiments, and describes the discharge threshold which is higher as the coolant temperature indicating the hydrogen gas temperature becomes higher.

Next, the control unit 13 compares the discharge threshold value acquired by referring to the map data with the purge flow rate and terminates the process when the purge flow rate is lower than the discharge threshold value, while it performs the processes of steps S12 and S13 and step S23 when the purge flow rate is equal to or greater than the discharge threshold value.

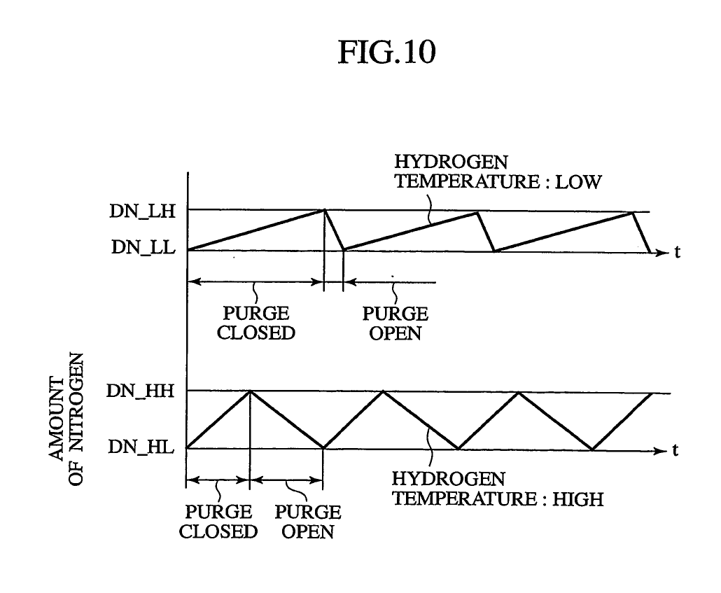

The fuel cell system which performs such a purge valve control process can change the amount of nitrogen in the hydrogen system as shown in FIG. 10 by the hydrogen gas temperature.

That is, when the temperature of the fuel cell stack 1 or the coolant is low and the hydrogen gas temperature is low, the vapor partial pressure corresponding to the hydrogen partial pressure of the gas flowing in the hydrogen electrode 1a is low, so that the control unit 13 can set an accumulation threshold value DN_LH or the integration value of the allowable amount of nitrogen that provides a high nitrogen density by referring to the map data as shown in FIG. 5, and can set a low discharge threshold value for the purge flow rate by referring to the map data as shown in FIG. 8. In the fuel cell system, therefore, when the amount of nitrogen becomes the accumulation threshold value DN_LH when the hydrogen purge valve 8 is in the closed state, the control unit 13 sets the hydrogen purge valve 8 in the open state to discharge the purge flow rate equivalent to the discharge threshold value and when the value becomes an amount of nitrogen DN_LL lower than the accumulation threshold value DN_LH, the control unit 13 sets the hydrogen purge valve 8 in the closed state. Accordingly, the fuel cell system can change the amount of nitrogen between the accumulation threshold value DN_LH and the amount of nitrogen DN_LL.

According to this fuel cell system, when the temperature of the fuel cell stack 1 or the coolant is high and the hydrogen gas temperature is high, there is a lots of vapor included in the gas in the hydrogen system which is circulated to the fuel cell stack 1, so that the partial pressure of hydrogen included in the gas to be circulated is low. In the fuel cell system, therefore, the control unit 13 should set it to an accumulation threshold value DN_HH lower than the accumulation threshold value DN_LH by referring to map data as shown in FIG. 5 in order to secure a sufficient hydrogen circulation amount.

In the fuel cell system, when the temperature of the fuel cell stack 1 is high, the flow rate of transmitted nitrogen to the hydrogen electrode 1a from the air electrode 1b increases, so that the increase speed of the amount of nitrogen becomes faster and the purge flow rate of an impurity, such as nitrogen, per unit time becomes smaller as shown in FIG. 6, making the decrease speed of the amount of nitrogen slower. Therefore, the control unit 13 sets the discharge threshold value of the purge flow rate which reduces the amount of nitrogen to an amount of nitrogen DN_HL by referring to map data as shown in FIG. 8. As the increase speed of the amount of nitrogen is fast, the discharge threshold value when the hydrogen gas temperature is high becomes the purge flow rate that has a greater size of reduction than the size of reduction from the amount of nitrogen DN_LH when the hydrogen gas temperature is low to the amount of nitrogen DN_LL.

Although the control unit 13 respectively sets the amount of nitrogen at the end of purging to DN_LL and DN_HL for a low temperature and a high temperature, it may set the discharge threshold value which sets the hydrogen purge valve 8 in the open state, when the hydrogen gas temperature is low until the amount of nitrogen becomes DN_HL. When such a discharge threshold value is set, the time for the amount of nitrogen to increase to the accumulation threshold value DN_LH from the amount of nitrogen DN_HL after purging ends becomes longer, thereby making it possible to elongate the period of setting the hydrogen purge valve 8 in the open state as a consequence. If the accumulation amount of nitrogen at the end of purging when the hydrogen gas temperature is low is set to DN_HL, however, the time to set the hydrogen purge valve 8 in the open state becomes longer as compared with the case where the amount of nitrogen DN_LL is set, so that the amount of hydrogen to be discharged increases, thereby reducing the efficiency of hydrogen usage. It is therefore desirable that the fuel cell system should set the amount of nitrogen DN_LL for the accumulation threshold value DN_HL in such a way as to provide the opening time of the hydrogen purge valve 8 that can suppress a reduction in the efficiency of hydrogen usage to minimum.

As described above in detail, according to the fuel cell system of the second embodiment to which the present invention is adapted, the control unit 13 sets the discharge threshold value which is the discharge gas flow rate higher as the coolant temperature is higher and the gas temperature in the hydrogen system is higher, and operates the hydrogen purge valve 8 to be in the closed state from the open state when the purge flow rate or the integration value discharged from the hydrogen purge valve 8 becomes the discharge threshold value. This configuration can set the period of setting the hydrogen purge valve 8 in the open state and the time of holding the hydrogen purge valve 8 in the open state in such a way as to suppress the amount of hydrogen to be discharged to minimum, regardless of the gas temperature in the hydrogen system. Therefore, the fuel cell system can maintain impurities in the hydrogen system equal to or smaller than the accumulation threshold value, and suppress a reduction in the efficiency of hydrogen usage.

According to the fuel cell system, in the purge valve control process where the hydrogen purge valve 8 is operated to the open state from the closed state, the control unit 13 sets the integration initial value smaller as the temperature of the fuel cell stack 1 is higher. Accordingly, this configuration can set the amount of nitrogen, reduced by setting the hydrogen purge valve 8 in the open state according to the discharge threshold value, to the integration initial value and can execute the first purge valve control process where the hydrogen purge valve 8 is operated to the dosed state from the open state. Accordingly, the fuel cell system can start integrating the amount of nitrogen form the integration initial value in the first purge valve control process where the hydrogen purge valve 8 is operated to the closed state. Even when different discharge threshold values are set depending on the temperature of the fuel cell stack 1, the accurate actual accumulation amount of nitrogen can be acquired in the next purge valve control process. Therefore, the fuel cell system can more reliably maintain impurities in the hydrogen system equal to or smaller than the accumulation threshold value. With regard to the process of executing the next purge valve control process by setting the integration initial value which changes with the temperature of the fuel cell stack 1 is set, it is possible to set the integration initial value following step S13 and acquire the amount of nitrogen using the integration initial value in the next step S4.

The above embodiments are only examples of the present invention. Therefore, the present invention is not limited by the embodiments and various modifications with respect to designs are made possible by embodiments apart from the ones described above, within the technical spirit of the present invention.

That is, although the description of the above-described fuel cell system has been given of the case where the ejector pump 7 is used to circulate hydrogen, it may be circulated by using a pump or a blower. Even when using a pump or a blower, as the nitrogen density and the vapor partial pressure rise, the hydrogen partial pressure falls, making the amount of hydrogen supply of the fuel cell stack 1 insufficient, however the effects as described in the above-described case can be demonstrated by performing a purge valve control process similar to that in the case of the ejector pump 7.

While the detection positions for the hydrogen pressure and the air pressure are the inlet ports of the fuel cell stack 1 for hydrogen and air in the above-described fuel cell system, they may be on the side where air and hydrogen are discharged from the fuel cell stack 1 or while the detection position for the coolant temperature is the coolant outlet port of the fuel cell stack 1, it may be on the inlet side, and it is needless to say that the temperatures of hydrogen and air can be detected directly.

The entire content of a Patent Application No. TOKUGAN 2003-43096 with a filing date of Feb. 20, 2003, and a Patent Application No. TOKUGAN 2003-389253 with a filing date of Nov. 19, 2003, is hereby incorporated by reference.

Although the invention has been described above by reference to certain embodiments of the invention, the invention is not limited to the embodiments described above. Modifications and variations of the embodiments described above will occur to those skilled in the air in light of the teachings. The scope of the invention is defined with reference to the following claims.

### INDUSTRIAL APPLICABILITY

The present invention can be adapted to a process of supplying a fuel gas and an oxidant gas to the fuel cell stack to generate power, thereby driving a vehicle driving motor.

1. A fuel cell system comprising:
a fuel cell stack having a fuel electrode and an oxidant electrode provided facing each other with an electrolyte membrane in between;
a gas supply unit which supplies a fuel gas to the fuel electrode and supplies an oxidant gas to the oxidant electrode to cause the fuel cell stack to generate power;
a circulation unit having a circulation passage to return an excess fuel gas, discharged from the fuel cell stack, to a fuel gas inlet port of the fuel cell stack;
a gas discharge unit having an open/close valve which discharges a gas present on the fuel electrode from the circulation passage; and
a control unit which calculates an integration value resulting from integration of a value per unit time concerning a gas to be supplied to the fuel electrode, which varies in accordance with a gas pressure of the oxidant electrode and a temperature of the fuel cell stack, when the open/close valve is set in a closed state, and controls the open/close valve in an open state when the integration value becomes equal to or greater than an accumulation threshold value.

2. The fuel cell system according to claim 1, wherein the control unit calculates the integration value by making the value per unit time concerning the gas to be supplied to the fuel electrode larger as the temperature of the fuel cell stack gets higher.

3. The fuel cell system according to claim 1, wherein the control unit calculates the integration value by making the value per unit time concerning the gas to be supplied to the fuel electrode larger as the gas pressure of the oxidant electrode becomes higher.

4. The fuel cell system according to claim 1, wherein the control unit controls the open/close valve by making the accumulation threshold value smaller as a temperature of the fuel gas becomes higher.

5. The fuel cell system according to claim 4, further comprising:
a coolant medium supply unit which supplies a coolant medium to the fuel cell stack; and
a coolant medium temperature detecting unit which detects a temperature of the coolant medium,
wherein the control unit predicts the temperature of the fuel cell stack or the fuel gas temperature based on the coolant medium temperature detected by the coolant medium temperature detecting unit, and changes the accumulation threshold value.

6. A fuel cell system comprising:
a fuel cell stack having a fuel electrode and an oxidant electrode provided facing each other with an electrolyte membrane in between;
a gas supply unit which supplies a fuel gas to the fuel electrode and supplies an oxidant gas to the oxidant electrode to cause the fuel cell stack to generate power;
a circulation unit having a circulation passage to return an excess fuel gas, discharged from the fuel cell stack, to a fuel gas inlet port of the fuel cell stack;
a gas discharge unit having an open/close valve which discharges a gas present on the fuel electrode from the circulation passage; and
a control unit which calculates an integration value resulting from integration of a discharge gas flow rate from the open/close valve, which varies in accordance with a gas pressure of the fuel electrode and a temperature of the fuel gas, when the open/close valve is set in an open state, and controls the open/close valve in a closed state when the integration value becomes equal to or greater than a discharge threshold value.

7. The fuel cell system according to claim 6, wherein the control unit calculates the integration value by making the discharge gas flow rate from the open/close valve smaller as the temperature of the fuel gas discharged from the open/close valve is higher.

8. The fuel cell system according to claim 6, wherein the control unit calculates the integration value by making the discharge gas flow rate from the open/close valve smaller as the gas pressure of the fuel electrode is lower.

9. The fuel cell system according to claim 6, wherein the control unit makes the discharge threshold value larger as the fuel gas temperature of the fuel electrode is higher.

10. The fuel cell system according to claim 9, further comprising:
a coolant medium supply unit which supplies a coolant medium to the fuel cell stack; and
a coolant medium temperature detecting unit which detects a temperature of the coolant medium,
wherein the control unit predicts the fuel gas temperature based on the coolant medium temperature detected by the coolant medium temperature detecting unit, and calculates the integration value.

11. A fuel cell system comprising:
a fuel cell stack having a fuel electrode and an oxidant electrode provided facing each other with an electrolyte membrane in between;
a gas supply unit which supplies a fuel gas to the fuel electrode and supplies an oxidant gas to the oxidant electrode to cause the fuel cell stack to generate power;
a circulation unit having a circulation passage to return an excess fuel gas, discharged from the fuel cell stack to a fuel gas inlet port of the fuel cell stack;
a gas discharge unit having an open/close valve which discharges a gas present on the fuel electrode from the circulation passage; and
a control unit which controls an open/closed state of the open/close valve,
wherein the control unit calculates an integration value resulting from integration of a value per unit time concerning a gas to be supplied to the fuel electrode, which varies in accordance with a gas pressure of the oxidant electrode and a temperature of the fuel cell stack, when the open/close valve is set in a closed state, and controls the open/close valve in an open state when the integration value becomes equal to or greater than an accumulation threshold value, and
calculates an integration value resulting from integration of a discharge gas flow rate from the open/close valve, which varies in accordance with a gas pressure of the fuel electrode and a temperature of the fuel gas, when the open/close valve is set in an open state, controls the open/close valve in a closed state when the integration value becomes equal to or greater than a discharge threshold value, and sets an initial value of the integration value to be calculated in case of controlling the open/close valve in the open state lower as the temperature of the fuel cell stack when the open/close valve is operated to the closed state from the open state is higher.

12. A control method of a fuel cell system which comprises a fuel cell stack having a fuel electrode and an oxidant electrode provided facing each other with an electrolyte membrane in between, a gas supply unit which supplies a fuel gas to the fuel electrode and supplies an oxidant gas to the oxidant electrode to cause the fuel cell stack to generate power, a circulation unit having a circulation passage to return an excess fuel gas, discharged from the fuel cell stack, to a fuel gas inlet port of the fuel cell stack, and a gas discharge unit having an open/close valve which discharges a gas present on the fuel electrode from the circulation passage, comprising steps of:
calculating an integration value resulting from integration of a value per unit time concerning a gas to be supplied to the fuel electrode, which varies in accordance with a gas pressure of the oxidant electrode and a temperature of the fuel cell stack, when the open/close valve is set in a closed state; and
controlling the open/close valve in an open state when the integration value becomes equal to or greater than an accumulation threshold value.

13. A control method of a fuel cell system which comprises a fuel cell stack having a fuel electrode and an oxidant electrode provided facing each other with an electrolyte membrane in between, a gas supply unit which supplies a fuel gas to the fuel electrode and supplies an oxidant gas to the oxidant electrode to cause the fuel cell stack to generate power; a circulation unit having a circulation passage to return an excess fuel gas, discharged from the fuel cell stack, to a fuel gas inlet port of the fuel cell stack, and a gas discharge unit having an open/close valve which discharges a gas present on the fuel electrode from the circulation passage, comprising steps of:
calculating an integration value resulting from integration of a discharge gas flow rate from the open/close valve, which varies in accordance with a gas pressure of the fuel electrode and a temperature of the fuel gas, when the open/close valve is set in an open state; and
controlling the open/close valve in a closed state when the integration value becomes equal to or greater than a discharge threshold value.

14. A control method of a fuel cell system which comprises a fuel cell stack having a fuel electrode and an oxidant electrode provided facing each other with an electrolyte membrane in between, a gas supply unit which supplies a fuel gas to the fuel electrode and supplies an oxidant gas to the oxidant electrode to cause the fuel cell stack to generate power, a circulation unit having a circulation passage to return an excess fuel gas, discharged from the fuel cell stack, to a fuel gas inlet port of the fuel cell stack, a gas discharge unit having an open/close valve which discharges a gas present on the fuel electrode from the circulation passage, comprising steps of:
calculating an integration value resulting from integration of a value per unit time concerning a gas to be supplied to the fuel electrode, which varies in accordance with a gas pressure of the oxidant electrode and a temperature of the fuel cell stack, when the open/close valve is set in a closed state;
controlling the open/close valve in an open state when the integration value becomes equal to or greater than an accumulation threshold value;
calculating an integration value resulting from integration of a discharge gas flow rate from the open/dose valve, which varies in accordance with a gas pressure of the fuel electrode and a temperature of the fuel gas, when the open/close valve is set in an open state;
controlling the open/close valve in a closed state when the integration value becomes equal to or greater than a discharge threshold value; and
setting an initial value of the integration value to be calculated in case of controlling the open/close valve in the open state lower as the temperature of the fuel cell stack when the open/close valve is operated to the closed state from the open state is higher.
